(19) United States
(12) Patent Application Publication
(10) Pub. No.: US 2020/0267912 A1
(43) Pub. Date: Aug. 27, 2020

(54) Double Sided Root Barrier

(71) Applicant: Tom Smith, Anaheim, CA (US)

(72) Inventor: Tom Smith, Anaheim, CA (US)

(21) Appl. No.: 16/282,692

(22) Filed: Feb. 22, 2019

(51) Int. Cl. A01G 13/02; A01G 9/28

(52) U.S. Cl. CPC A01G 13/0237; A01G 9/28

(57) ABSTRACT

A double-sided root barrier has an inside channel formed on an inside surface. The inside channel is formed between the inside channel inside surface and the transition area inside surface. The transition area inside surface is formed at an angle to an outside channel inside surface. The outside channel inside surface is formed at an angle to the inside surface. An outside channel is formed on an outside surface, and the outside channel is formed between an outside channel outside surface and a transition area outside surface. The transition area outside surface is parallel to the transition area inside surface. The outside channel outside surface is parallel to the outside channel inside surface, and the transition area outside surface is formed at an angle to the inside channel outside surface.

### FIELD OF THE INVENTION

The present invention is in the field of root barriers.

### DISCUSSION OF RELATED ART

A variety of different root barriers have been invented for controlling root growth in trees and plants. Root barriers are common landscape installations. For example, in U.S. Pat. No. 5,070,642 to inventor Albrecht issued Dec. 10, 1991, the disclosure of which is incorporated herein by reference, a root deflector having a number of panels is disclosed for directing roots downwardly. The panels are connected together by tea section connector rails that meet with corresponding connector sleeves, In U.S. Pat. No. 4,665,645 to inventor Schau III et.al. issued May 19, 1987, the disclosure of which is incorporated herein by reference, the planter box. is biodegradable and formed from thick interconnecting planks. In U.S. Pat. No. 4,995,191 issued Feb. 26, 1991 to inventor Davis, the disclosure of which is incorporated herein by reference, a combined root barrier and watering collar is provided by a frustro conical panelized root deflector configuration.

### SUMMARY OF THE INVENTION

A double-sided root barrier has an inside channel formed on an inside surface. The inside channel is formed between the inside channel inside surface and the transition area inside surface, The transition area inside surface is formed at an angle to an outside channel inside surface. The outside channel inside surface is formed at an angle to the inside surface. An outside channel is formed on an outside surface, and the outside channel is formed between an outside channel outside surface and a transition area outside surface. The transition area outside surface is parallel to the transition area inside surface. The outside channel outside surface is parallel to the outside channel inside surface, and the transition area outside surface is formed at an angle to the inside channel outside surface. The inside channel outside surface is formed at an angle to the outside surface. The inside channel outside surface is parallel to the inside channel inside surface.

Optionally, the double-sided root barrier has an inside channel outside surface that extends upwardly to an inside channel top outside edge. The transition area outside surface extends upwardly to a transition area top outside edge. The outside channel outside surface extends upwardly to an outside channel top outside edge. The inside channel inside surface extends upwardly to an inside channel top inside edge. The transition area inside surface extends upwardly to a transition area top inside edge. The outside channel inside surface extends upwardly to an outside channel top inside edge. The inside channel top outside edge is parallel to the inside channel top inside edge. The transition area top outside edge is parallel to the transition area top inside edge. The outside channel top outside edge is parallel to the outside channel top inside edge.

The inside channel has an inside channel outside edge and an inside channel groove apex. The outside channel has an outside channel inside edge and an outside channel groove apex. The outside channel has an outside channel inside bend opposite an outside channel outside bend. The outside channel inside bend and the outside channel outside bend connect to the main sidewall section. The outside channel inside bend is connected to the inside surface, and the outside channel outside bend is connected to the outside surface.

The inside channel has an inside channel outside bend opposite an inside channel inside bend. The inside channel outside bend is connected to the outside surface, and the inside channel inside bend is connected to the inside surface. The outside channel is formed with an outside acute angle between the outside channel outside surface and the transition, area outside surface.

The inside channel is formed with an inside acute angle between the inside channel outside surface and the transition area inside surface.

### BRIEF DESCRIPTION OF THE DRAWINGS

FIG. 1 is a perspective view of the prior art.

FIG. 2 is a perspective view of the present invention.

FIG. 3 is a cross-section diagram of the present invention.

FIG. 4 is a cross-section diagram showing construction of the double-sided root barrier.

FIG. 5 is a perspective view of the installed root barrier.

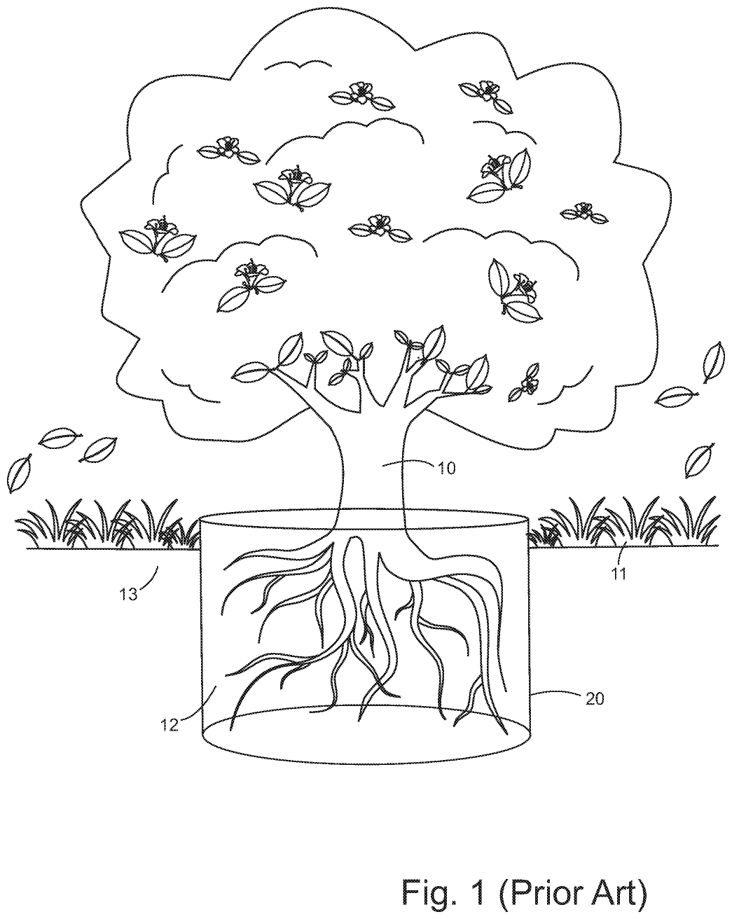

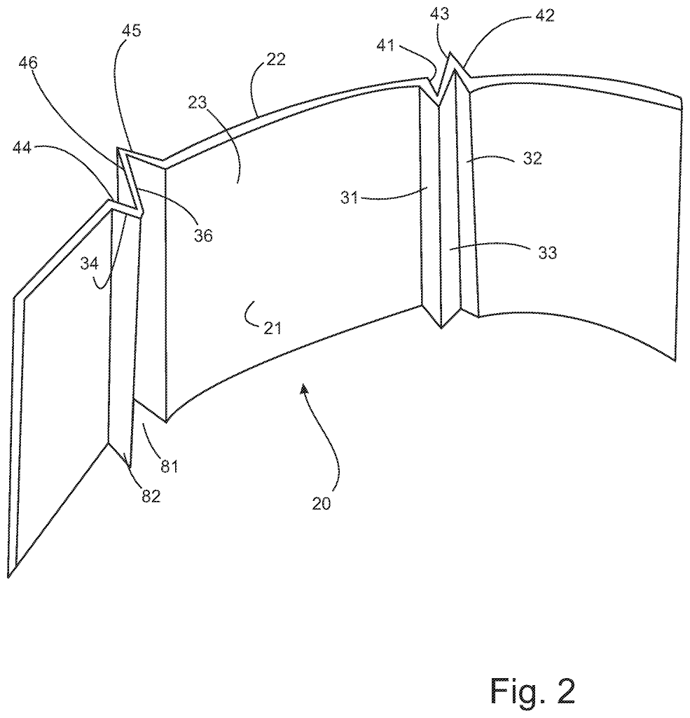

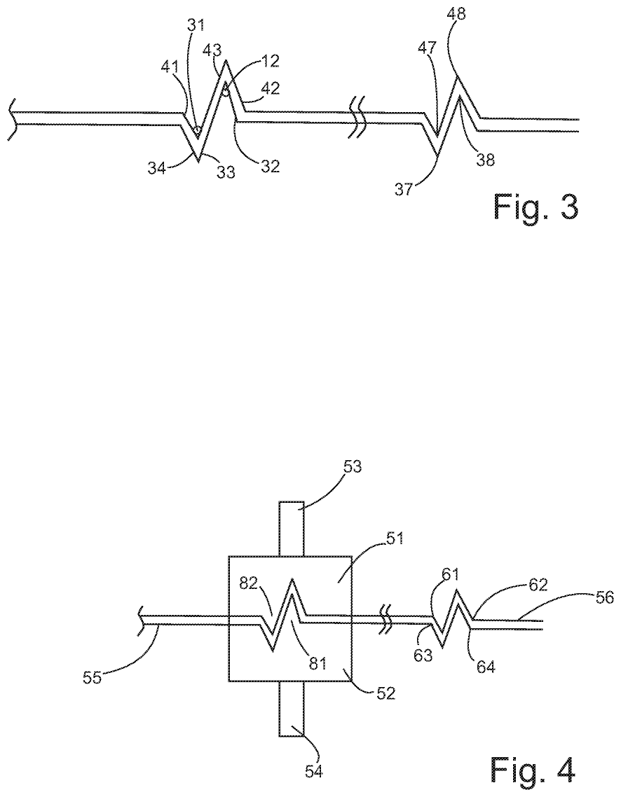

### The following call out list of elements can be a useful'guide in referencing the element numbers of the drawings.

10 tree
11 plants
12 inside roots
13 outside roots
20 root barrier
21 inside surface
22 outside surface
23 main sidewall section
31 outside channel inside surface
32 inside channel inside surface
33 transition area inside surface
34 outside channel top inside edge
35 inside channel top inside edge
36 transition area top inside edge
37 outside channel inside edge
38 inside channel groove apex
41 outside channel outside surface
42 inside channel outside surface
43 transition area outside surface
44 outside channel top outside edge
45 inside channel top outside edge
46 transition area top outside edge
47 outside channel groove apex
48 inside channel outside edge
51 upper press mold
52 lower press mold
53 upper press mold mechanism
54 lower press mold mechanism
55 continuous roll
61 outside channel outside bend
62 inside channel outside bend
63 outside channel inside bend
64 inside channel inside bend
81 inside channel
$2 outside channel
88 outside acute angle
89 inside acute angle

### DETAILED DESCRIPTION OF THE PREFERRED EMBODIMENT

As seen in the first figure, the prior an root barrier 20 encloses a tree 10 so that the inside roots 12 of the tree do not commingle with the outside roots 13 of the plants 11. The prior art root harrier 20 is generally smooth and lacking channels.

The present invention disclosed in the second figure that adds an inside channel and an outside channel to the prior art root barrier. The inside channel 81 has inside surface and an outside surface and the outside channel 82 has an inside surface 21 and an outside surface 22. Typically the inside surface is facing the tree and the outside surface is facing plants and grass.

The root barrier 20 has an inside surface 21 that includes a main sidewall section 23. The channels are formed between the main sidewall sections. An inside channel has an inside channel inside surface 32 that is angled outwardly. The inside channel inside surface 32 is formed at an angle to the transition area inside surface 33. The transition area inside, surface 33 is thrilled and angle to the outside channel inside surface 31. The sections of the outside channel inside surface 31, the transition area inside surface 33 and the inside channel inside surface 32 form a zigzag pattern for catching roots of the tree 10 and directing them downwardly. The zigzag pattern has an inside channel groove apex 38 that collects inside roots 12 of the tree 10 and encourages them to grow downwardly, as seen in the third figure, The transition area inside surface 33 and the inside channel inside surface 32. form an outwardly pointing V shaped angle that is preferably an acute angle,

The root barrier 20 also has an outside channel outside surface 41 that is inwardly pointing and also formed at an angle. to the transition area outside surface 43. The transition area outside surface 43 is then connected at an angle to the inside channel outside surface 42. The inside channel outside surface 42 is outwardly pointing and is connected to the main sidewall section 23. The outside channel outside surface 41 and the transition area outside surface 43 form an inwardly pointing V shaped angle that is preferably an acute angle. The inwardly pointing be shaped angle is the outside channel groove apex 47 that collects outside roots 13 and urges them to grow downwardly, as seen in the third figure.

The outside surface 22 and the inside surface 21 meet at an upper edge of the root barrier 20. The upper edge is preferably slightly above the ground so that roots do not grow over the upper edge through the air. The height of the upper edge above the ground is determined by the species of trees and ground condition during installation. The upper edge has an inside edge that includes an outside channel top inside edge 34, and inside channel top inside edge 35, and a transition area top inside edge 36. The inside channel top inside edge 35 is formed at an angle to the transition area top inside edge 36, which is further formed at an angle to the outside channel top inside edge 32, as seen in the second figure. Similarly, the upper edge also has an outside edge including an outside channel top outside edge 44, and inside channel top outside edge 45, and a transition area top outside edge 46. The outside channel top outside edge 44 is fanned in an angle to the transition area top outside edge 46, which is further formed at an angle to the inside channel top outside edge 45. The upper edge is preferably flat so that roots growing upwardly are discouraged from crossing over the top of the upper edge.

The inside channel top outside edge 45 is parallel to the inside channel top inside edge 35. The transition area top outside edge 46 is parallel to the transition area top inside edge 36. The outside channel top outside edge 41 is parallel to the outside channel top inside edge 34. Similarly, the outside channel outside surface 41 is parallel to the outside channel inside surface 31. The transition area outside surface 43 is parallel to the transition area inside surface 33. The inside channel outside surface 42 is parallel to the inside channel inside surface 32. Additionally, the outside surface 22 is parallel to the inside surface 21. As a whole, the root barrier is preferably formed as a continuous sheet of high density UV stabilized polyethylene with a thickness of approximately 85 mil.

The inside channel top outside edge 45 preferably forms an acute angle with the transition area top outside edge 46. Similarly, the transition area top outside edge 46 preferably forms an acute angle with the outside channel top outside edge 44. The inside channel top inside edge 35 preferably forms an acute angle with the transition area top inside edge 36. The outside channel top inside edge 34 preferably forms an acute angle with the transition area top inside edge of 36.

Roots that grow sideways along the inside surface 21 or the outside surface 22 eventually meet the channels, either the outside channel or the inside channel. The inside roots of the tree engage with the inside channel groove apex 38 and the outside roots engage with the outside channel groove apex 47. Once the roots grow into the channels, the roots are urged downwardly in further growth so that the tree or plant has deeper roots. Preferably, the outside channel inside edge 37 and the inside channel outside edge 48 are protrusions that direct the roots into the channel grooves.

Some roots may be caught by bends rather than channels. For example, the outside channel inside bend 63 can receive some roots and direct them downwardly. Similarly, the inside channel outside bend 62 can receive some roots and direct them downwardly. The bends are formed from a continuous roll 55 of plastic. material such as polyethylene, polypropylene or polystyrene. The continuous roll 55 is pressed under heat and pressure between an upper press mold 51. and a lower press mold 52. The upper press mold 51 is preferably actuated by an upper press mold mechanism 53 and the lower press mold 52 is preferably actuated by a lower press mold mechanism 54. The press molds can be rotary or linearly actuated. A variety of mechanisms as shown in the prior art can be used for actuating the press molding. The press molds form the outside channel inside bend 63 which is opposed by the outside channel outside bend 61. Similarly, the inside channel inside bend 62 is opposed by the inside channel inside bend 64. The continuous roll 55 exits in an exit feed 56 and the exit feed can be rolled into another spool for delivery to the customer as seen in FIG. 4.

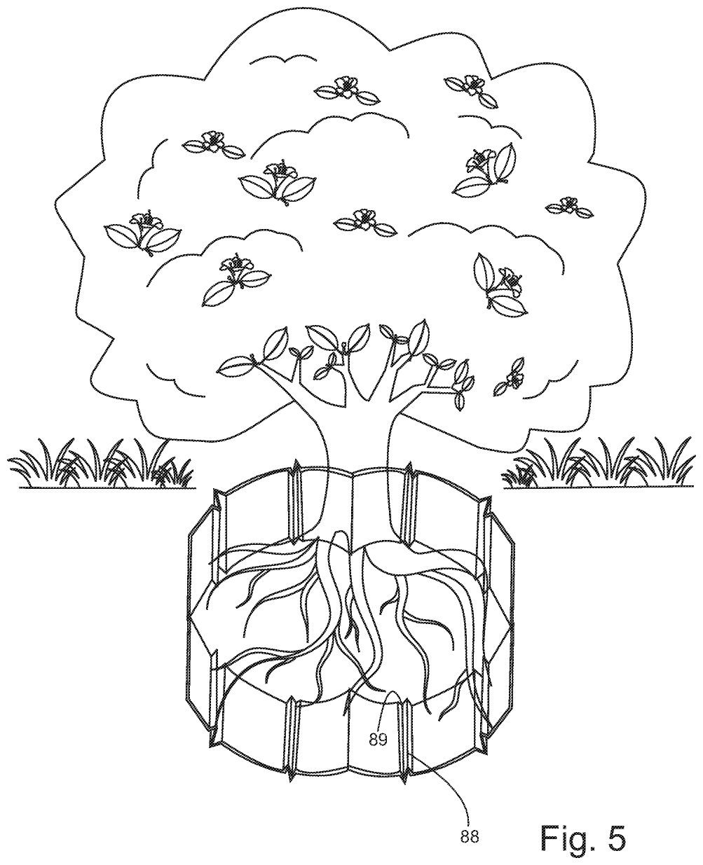

As seen in FIG. 5, the improved root barrier has an outside acute angle 88 for directing outside roots downwardly, and an inside acute angle 89 for directing inside roots downwardly.

The improved root barrier is preferably symmetrical on both sides so that it can be installed in either direction without consideration as to the orientation. This provides a double-sided root control solution for landscape installations. The inside channel opposes the outside channel in a zigzag configuration which also saves space in linear and surround configurations,

1. A double-sided root barrier comprising:
a. an inside channel formed on an inside surface, wherein the inside channel is formed between the inside channel inside surface and the transition area inside surface, wherein the transition area inside surface is formed at an angle to an outside channel inside surface, wherein the outside channel inside surface is formed at an angle to the inside surface;
b. an outside channel formed on an outside surface, wherein the outside channel is formed between an outside channel outside surface and a transition area outside surface, wherein the transition area outside surface is parallel to the transition area inside surface, wherein the outside channel outside surface is parallel to the outside channel inside surface, wherein the transition area outside surface is formed at an angle to the inside channel outside surface, wherein the inside channel outside surface is formed at an angle to the outside surface, wherein the inside channel outside surface is parallel to the inside channel inside surface;

2. The double-sided root barrier of claim 1, wherein the inside channel outside surface extends upwardly to an inside channel top outside edge, wherein the transition area outside surface extends upwardly to a transition area top outside edge, wherein the outside channel outside surface extends upwardly to an outside channel top outside edge, wherein the inside channel inside surface extends upwardly to an inside channel top inside edge, wherein the transition area inside surface extends upwardly to a. transition area top inside edge, wherein the outside channel inside surface extends upwardly to an outside channel top inside edge, wherein the inside channel top outside edge is parallel to the inside channel top inside edge, wherein the transition area top outside edge is parallel to the transition area top inside edge, wherein the outside channel top outside edge is parallel to the outside channel top inside edge.

3. file double-sided root barrier of claim 1 wherein the inside channel has an inside channel outside edge and an inside channel groove apex.

4. The double-sided root barrier of claim 1, wherein the outside channel has an outside channel inside edge and an outside channel groove apex.

5. The double-sided root barrier of claim 1, wherein the outside channel has an outside channel inside bend opposite an outside channel outside bend, wherein the outside channel inside bend and the outside channel outside bend connect to the main sidewall section, wherein the outside channel inside bend is connected to the inside surface, and wherein the outside channel outside bend is connected to the outside surface.

6. The double-sided root barrier of claim 1, wherein the inside channel has an inside channel outside bend opposite an inside channel inside bend, wherein the inside channel outside bend is connected to the outside surface, and wherein the inside channel inside bend is connected to the inside surface.

7. The double-sided root barrier of claim 1, wherein the outside channel is formed with an outside acute angle between the outside channel outside surface and the transition area outside surface.

8. The double-sided root barrier of claim 7, wherein the inside channel outside surface extends upwardly to an inside channel top outside edge, wherein the transition area outside surface extends upwardly to a transition area top outside edge, wherein the outside channel outside surface extends upwardly to an outside channel top outside edge, wherein the inside channel inside surface extends upwardly to an inside channel top inside edge, wherein the transition area inside surface extends upwardly to a transition area top inside edge, wherein the outside channel inside surface extends upwardly to an outside channel top inside edge, wherein the inside channel top outside edge is parallel to the inside channel top inside edge, wherein the transition area top outside edge is parallel to the transition area top inside edge, wherein the outside channel top outside edge is parallel to the outside channel top inside edge.

9. The double-sided root barrier of claim 7, wherein the inside channel has an inside channel outside edge and an inside channel groove apex.

10. The double-sided root barrier of claim 7, wherein the outside channel has an outside channel inside edge and an outside channel groove apex.

11. The double-sided root barrier of claim 7, wherein the outside channel has an outside channel inside bend opposite an outside channel outside bend, wherein the outside channel inside bend and the outside channel outside bend connect to the main sidewall section, wherein the outside channel inside bend is connected to the inside surface, and wherein the outside channel outside bend is connected to the outside surface.

12. The double-sided root barrier of claim 7, wherein the inside channel has an inside channel outside bend opposite an inside channel inside bend, wherein the inside channel outside bend is connected to the outside surface, and wherein the inside channel inside bend is connected to the inside surface.

13. The double-sided root barrier of claim 1, wherein the inside channel is formed with an inside acute angle between the inside channel outside surface and the transition area inside surface.

14. The double-sided root barrier of claim 13, wherein the inside channel outside surface extends upwardly to an inside channel top outside edge, wherein the transition area outside surface extends upwardly to a transition area top outside edge, wherein the outside channel outside surface extends upwardly to an outside channel top outside edge, wherein the inside channel inside surface extends upwardly to an inside channel top inside edge, wherein the transition area inside surface extends upwardly to a transition area top inside edge, wherein the outside channel inside surface extends upwardly to an outside channel top inside edge, wherein the inside channel top outside edge is parallel to the inside channel top inside edge, wherein the transition area top outside edge is parallel to the transition area top inside edge, wherein the outside channel top outside edge is parallel to the outside channel top inside edge.

15. The double-sided root barrier of claim 13, wherein the inside channel has an inside channel outside edge and an inside channel groove apex.

16. The double-sided root barrier of claim 13, wherein the outside channel has an outside channel inside edge and an outside channel groove apex.

17. The double-sided root barrier of claim 13, wherein the outside channel has an outside channel inside bend opposite an outside channel outside bend, wherein the outside channel inside bend and the outside channel outside bend connect to the main sidewall section, wherein the outside channel inside bend is connected to the inside surface, and wherein the outside channel outside bend is connected to the outside surface.

18. The double-sided root barrier of claim 13, wherein the inside channel has an inside channel outside bend opposite an inside channel inside bend, wherein the inside channel outside bend is connected to the outside surface, and wherein the inside channel inside bend is connected to the inside surface.

19. The double-sided root barrier of claim 1, wherein the inside channel is formed with an inside acute angle between the inside channel outside surface and the transition area inside surface. The double-sided root barrier of claim 1. wherein the outside channel is formed with an outside acute angle between the outside channel outside surface and the transition area outside surface.

20. The double-sided root barrier of claim 13, wherein the inside channel outside surface extends upwardly to an inside channel top outside edge, wherein the transition area outside surface extends upwardly to a transition area top outside edge, wherein the outside channel outside surface extends upwardly to an outside channel top outside edge, wherein the inside channel inside surface extends upwardly to an inside channel top inside edge, wherein the transition area inside surface extends upwardly to a. transition area top inside edge, wherein the outside channel inside surface extends upwardly to an outside channel top inside edge, wherein the inside channel top outside edge is parallel to the inside channel top inside edge, wherein the transition area top outside edge is parallel to the transition area top inside edge, wherein the outside channel top outside edge is parallel to the outside channel top inside edge, wherein the inside channel has an inside channel outside edge and an inside channel groove apex, wherein the outside channel has an outside channel inside edge and an outside channel groove apex, wherein the outside channel has an outside channel inside bend opposite an outside channel outside, bend, wherein the outside channel inside bend and the outside channel outside bend connect to the main sidewall section, wherein the outside channel inside bend is connected to the inside surface, and wherein the outside channel outside bend is connected to the outside surface, wherein the inside channel has an inside channel outside bend opposite an inside channel inside bend, wherein the inside channel outside bend is connected to the outside surface, and wherein the inside channel inside bend is connected to the inside surface.
